(19) United States
(12) Patent Application Publication
(10) Pub. No.: US 2008/0158853 A1
(43) Pub. Date: Jul. 3, 2008

(54) ILLUMINATING APPARATUS PROVIDING POLARIZED LIGHT

(75) Inventors: Young-chan KIM, Suwon-si (KR); Seung-ho Nam, Seongnam-si (KR); Jee-hong Min, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/833,337

(22) Filed: Aug. 3, 2007

(30) Foreign Application Priority Data
Dec. 27, 2006 (KR) 10-2006-0135010

(51) Int. Cl. F21V 9/14

(52) U.S. Cl. 362/19

(57) ABSTRACT

An illuminating apparatus which provides a polarized light is provided. The illuminating apparatus includes a light source; a first layer that guides light emitted from the light source and includes an incident surface to which the light is incident, an upper surface that emits the light, and a light facing surface facing the incident surface, wherein the incident surface has a prism pattern; a second layer formed on the first layer, and including exit units that are arranged in a repeating fashion in a first direction forming a predetermined angle Θ with respect to a first axis, which is in parallel with the light source; and a third layer formed on the second layer using an optically anisotropic material, an anisotropic axis of which is formed in a second direction that is perpendicular to the first direction. The light polarized in the second direction is emitted from the illuminating apparatus.

### CROSS-REFERENCE TO RELATED PATENT APPLICATIONS

This application claims priority from Korean Patent Application No. 10-2006-0135010, filed on Dec. 27, 2006, in the Korean Intellectual Property Office, the disclosure of which is incorporated herein in its entirety by reference.

### BACKGROUND OF THE INVENTION

1. Field of the Invention

Apparatuses consistent with the present invention relate to an illuminating apparatus providing polarized light and, more particularly, to an illuminating apparatus in which the polarization direction of emitted light can be easily varied.

2. Description of the Related Art

Flat panel displays are categorized into self-emissive displays that generate light themselves to produce an image and non-emissive displays that use light from an external light source to create an image. A representative example of a non-emissive display is a liquid crystal display (LCD). Therefore, the LCD requires an additional light source, that is, an illuminating apparatus such as a backlight unit.

Illuminating apparatuses can be classified as direct light type illuminating apparatuses and edge light type illuminating apparatuses according to how the light source is arranged. In the direct light type illuminating apparatus, a light source installed right under a liquid crystal panel directly irradiates light onto the liquid crystal panel. In the edge light type illuminating apparatus, a light source is disposed on a side surface of a light guide plate. The direct light type illuminating apparatus can be applied to large displays since the light source can be freely and efficiently disposed in a large area freely and efficiently, and the edge light type illuminating apparatus can be applied to displays of small sizes used in monitors or mobile phones since the light source is disposed on the side portion of the light guide plate so that the display can be easily fabricated to have a thin thickness and a small size.

Conventional LCDs use about 5% of the light emitted from the light source to display images. The low light utilization efficiency is caused by a light loss through the light guide plate and optical films disposed on the light guide plate, and in particular, by light absorption of a polarization plate and a color filter in the LCD. The LCD displays images by relying on the fact that arrangements of liquid crystal molecules are varied by the electric field and light incident on liquid crystal molecules is transmitted or blocked according to its polarization direction. That is, the LCD uses light that is linearly polarized in a particular direction, and includes light polarization plates on both surfaces of the LCD. The light polarization plates disposed on both surfaces of the LCD are absorptive polarization plates that transmit only the light polarized in the particular direction, and absorb light polarized in another direction. The light polarization plates absorb about 50% of incident light, and thus, become factors that contribute to the low light utilization efficiency.

In order to solve the above problem, research into an appropriate substitute for the absorptive polarization plate or research into improving the light utilization efficiency by changing the polarization direction of most of the incident light to be the same as that of a rear polarization plate disposed on a rear surface of the LCD are being actively performed. For example, a reflective polarization film having a multi-layered structure such as a dual brightness enhancement film (DBEF) can be attached to an upper surface of the light guide plate to improve the light utilization efficiency of the LCD. However, the additional polarization film is expensive, and there is a limitation in increasing the light utilization efficiency because a polarization conversion unit does not exist. Therefore, intensive research into a polarization light guide plate that can separate polarization and convert the polarization is required.

FIG. 1 shows a schematic structure of an illuminating apparatus providing polarized light according to the related art. The illuminating apparatus includes a light source 10, a first layer 15 formed of an isotropic material, a second layer 18 formed on the first layer 15, and a third layer 25 formed of an anisotropic material.

The second layer 18 is an adhesive layer having a prism array 20, and the third layer 25 is an anisotropic layer having a refractive index which varies with respect to a polarization direction of incident light. For example, the third layer 25 has a first refractive index that is larger than those of the first and second layers 15 and 18 with respect to a light I₁ of a first polarization, and has a second refractive index that is nearly equal to those of the first and second layers 15 and 18 with respect to a light I₂ of a second polarization. Therefore, the light I₂ having the second polarization straightly transmits through a boundary between the first and second layers 15 and 18 and a boundary between the second and third layers 18 and 25, and is totally reflected by the upper surface of the third layer 25 and not emitted. Meanwhile, the light I₁ having the first polarization is refracted by a first surface 20a that is the boundary between the second and third layers 18 and 25, and at this time, an exit angle of the light I₁ is smaller than the incident angle, and thus, the light I₁ goes toward a second surface 20b. Then, the light I₁ is totally reflected by the second surface 20b toward the upper surface of the third layer 25, and is incident on the upper surface at an angle that is smaller than a critical angle generating the total reflection, and thus, the light I₁ is emitted upward.

As described above, since the light is separately emitted according to the polarization using the refractive index that varies with respect to the polarization direction, light of a certain polarization can be emitted and the number of optical films disposed on the polarization plate can be reduced. However, the above structure emits light having a polarization that is parallel to a horizontal axis or a vertical axis of the display panel, and thus, can be applied to a vertical alignment (VA) mode which uses light polarized in parallel with the axial direction. Therefore, the above structure requires an optical film such as a quarter wave plate in order to be applied to a twisted nematic (TN) mode which uses light polarized in a direction that is slanted with respect to the axis.

### SUMMARY OF THE INVENTION

Exemplary embodiments of the present invention provide an illuminating apparatus in which the polarization of exit light can easily be adjusted in order to correspond to various liquid crystal modes without using an additional optical film.

According to an aspect of the present invention, there is provided an illuminating apparatus comprising a light source, a first layer which guides light emitted from the light source and which includes an incident surface onto which the light is incident, an upper surface which emits the light, and a light facing surface facing the incident surface, where the incident surface has a prism pattern, a second layer formed on the first layer and including exit units that are arranged in a repeating fashion in a first direction which forms a predetermined angle θ with respect to a first axis parallel with the light source, and a third layer formed on the second layer using an optically anisotropic material, an anisotropic axis of which is formed in a second direction that is perpendicular to the first direction, wherein light polarized in the second direction is emitted from the illuminating apparatus.

According to another aspect of the present invention, there is provided an illuminating apparatus comprising a light source, a first layer which guides light emitted from the light source and which includes an incident surface onto which the light is incident, an upper surface which emits the light, and a light facing surface facing the incident surface, a second layer formed on the first layer and including exit units that are arranged in a repeating fashion in a first axis direction that is perpendicular to the incident surface, a third layer formed on the second layer using an optically anisotropic material, and a diffusing film formed on the third layer, and including a base film formed of an anisotropic material and beads attached to the base film to scatter the light, wherein light polarized in a direction forming a predetermined angle with the first axis is emitted from the illuminating apparatus.

### BRIEF DESCRIPTION OF THE DRAWINGS

The patent or application file contains at least one drawing executed in color. Copies of this patent or patent application publication with color drawings will be provided by the Office upon request and payment of the necessary fee.

The above and other features and advantages of the present invention will become more apparent by describing in detail exemplary embodiments thereof with reference to the accompanying drawings, in which:

FIG. 1 is a cross-sectional view of an illuminating apparatus providing polarized light according to the related art;

FIG. 2 is an exploded perspective view of an illuminating apparatus providing polarized light according to an exemplary embodiment of the present invention;

FIGS. 3A and 3B are cross-sectional views of the illuminating apparatus of FIG. 2 from different views;

FIG. 4 is a diagram showing polarization distribution of exit light when an angle θ is 45° in the illuminating apparatus of FIG. 2;

FIG. 5 is a diagram showing polarization distribution of exit light when the angle θ 60° in the illuminating apparatus of FIG. 2; and

FIG. 6 is a cross-sectional view of an illuminating apparatus providing polarized light according to another exemplary embodiment of the present invention.

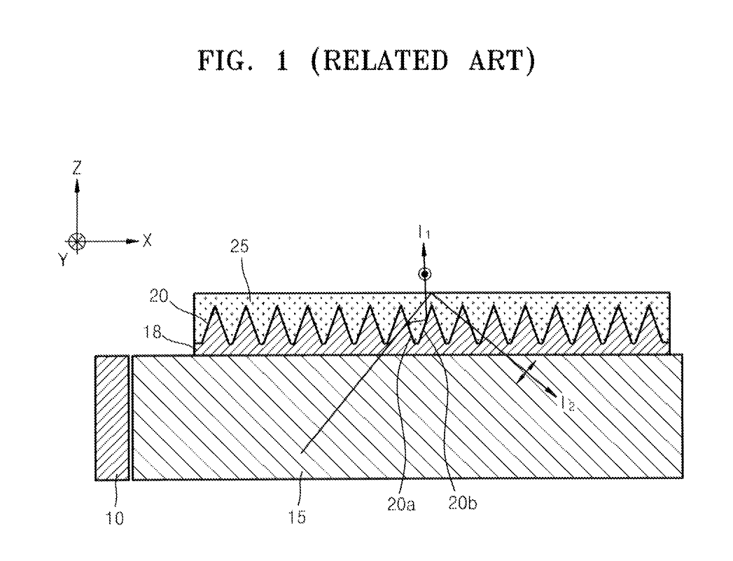

### DETAILED DESCRIPTION OF EXEMPLARY EMBODIMENTS OF THE INVENTION

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity. Like reference numerals in the drawings denote like elements, and thus their description will be omitted.

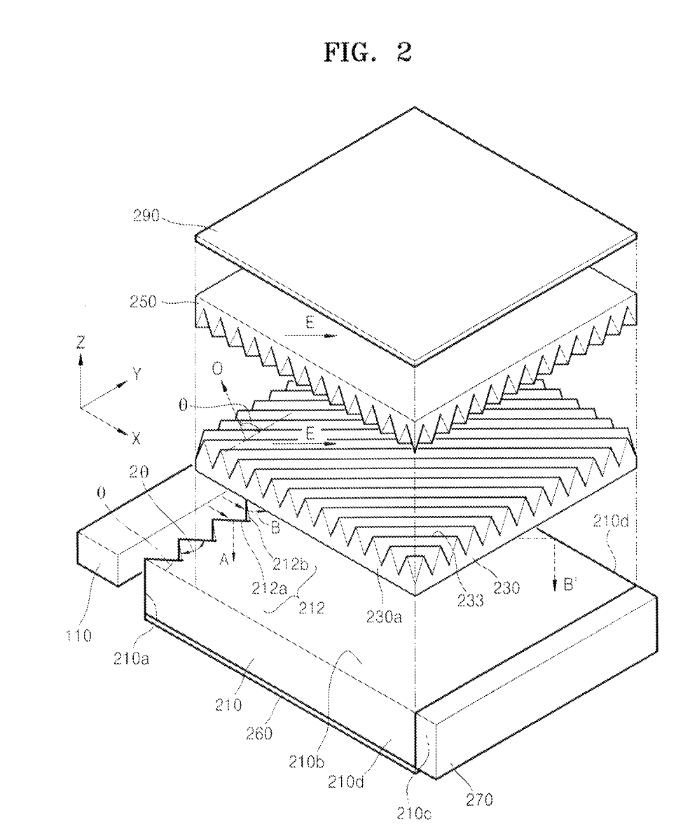

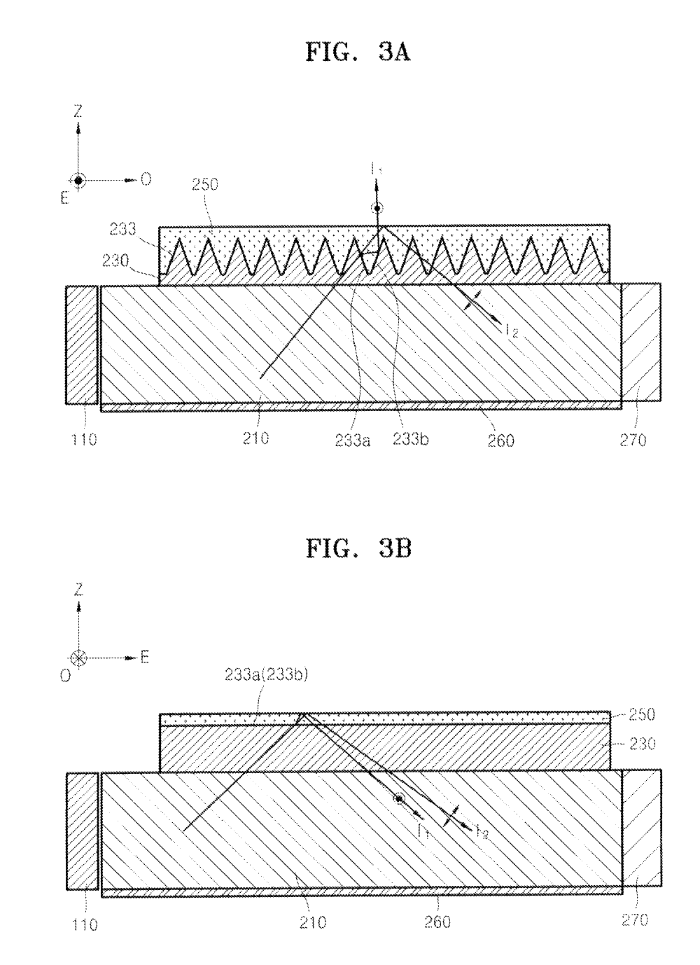

FIG. 2 is an exploded perspective view of an illuminating apparatus providing polarized light according to an exemplary embodiment of the present invention, and FIGS. 3A and 3B are cross-sectional views of the illuminating apparatus from different views. Referring to FIGS. 2, 3A, and 3B, the illuminating apparatus of the current embodiment includes a light source 110, a first layer 210 which guides light emitted from the light source 110, a second layer 230, on which exit units 233 are arranged in a repeating fashion, formed on the first layer 210, and a third layer 250 formed of an optically anisotropic material on the second layer 230.

A line light source such as a cold cathode fluorescent lamp (CCFL) or a point light source such as a light emitting diode (LED) can be used as the light source 110.

The first layer 210 is formed of an optically isotropic material to guide the light emitted from the light source 110, and includes an incident surface 210a, onto which the light is incident, an upper surface 210b from which the light exits, and a light facing surface 210c facing the incident surface 210a. A pattern formed of a plurality of prisms 212 is formed on the incident surface 210a. The prism pattern 212 includes a first surface 212a and a second surface 212b. The first surface 212a is disposed in parallel with a length direction E of the exit units 233, which will be described later, to make an angle θ with an X axis. That is, the first surface 212a is inclined at an angle 90°-Θ with respect to the axis (Y axis) parallel to the light source 110. The angle of the vertexes of the prism pattern 212 may be 2θ. In addition, side surfaces 210d connecting the incident surface 210a to the light facing surface 210c may be formed as reflective surfaces.

The second layer 230 is formed of an optically isotropic material, and the exit units 233 are arranged in repeating fashion on the second layer in a first direction O that forms a predetermined angle θ with a first axis (Y axis) that is in parallel to the light source 110. The length direction (second direction) E of the exit units 233 forms a predetermined angle θ with the second axis (X axis). The exit units 233 can be formed, for example, as prisms having a third surface 233a and a fourth surface 233b. The refractive index of the second layer 230 is equal to or similar to that of the first layer 210.

The third layer 250 is formed on the second layer 230 using an optically anisotropic material. That is, the third layer 250 has a refractive index nₑ with respect to extraordinary light having a first polarization, and a refractive index nₒ with respect to ordinary light having a second polarization. An anisotropic axis of the third layer 250 is formed in the length direction E of the exit unit 233. The refractive index of the third layer 250 with respect to the light having the second polarization is equal to or similar to those of the first and second layers 210 and 230, and the refractive index of the third layer 250 with respect to the light having the first polarization is larger than those of the first and second layers 210 and 230.

A reflective member 260 can be disposed on a lower surface of the first layer 210, and a polarization conversion member 270 can be disposed on the light facing surface 210c. In addition, a distribution plate 290 that evenly distributes the exit light can be disposed on the upper portion of the third layer 250.

Processes of emitting polarized light by the illuminating apparatus according to the current embodiment are as follows. The light irradiated from the light source 110 is refracted by the first surface 212a or the second surface 212b of the prism pattern 212, and then, is incident on the first layer 210 with an angle that is smaller than a critical angle with respect to a line perpendicular to each of the surfaces. The light passing the first surface 212a proceeds along a path A. Referring to FIG. 3A, the light I₁ having the first polarization among the light proceeding in the path A is refracted by the third surface 233a toward the fourth surface 233b of the exit unit 233, and then, is totally reflected upward by the fourth surface 233b. The light I₂ having the second polarization is transmitted through the layers without being refracted, and then, is incident onto the upper surface of the third layer 250 at an angle that is larger than the critical angle and is totally reflected by the upper surface of the third layer 250. The light passing through the second surface 212b proceeds along a path B. Referring to FIG. 3B, the light I₁ having the first polarization among the light proceeding in the path B is refracted by the first surface 233a or the second surface 233b, and proceeds toward the upper surface of the third layer 250, and is totally reflected by the upper surface of the third layer 250. In addition, the light I₂ having the second polarization passes through the layers without being refracted, and is totally reflected by the upper surface of the third layer 250, and thus, the light I₂ is not emitted upward. The light proceeding along the path B proceeds along a path B′ after being reflected by the side surface 210d of the first layer 210. In a case where the vertical angle of the prism pattern 212 is 2θ, the path B′ coincides with the path A, and thus, as shown in FIG. 3A, the light having the first polarization and the light having second polarization are separated and the light having the first polarization is emitted upward. The light having the second polarization that is not emitted upward proceeds in the first layer 210, and then, is emitted upward when the polarization direction of the light is changed into the first polarization direction by the polarization conversion member 270.

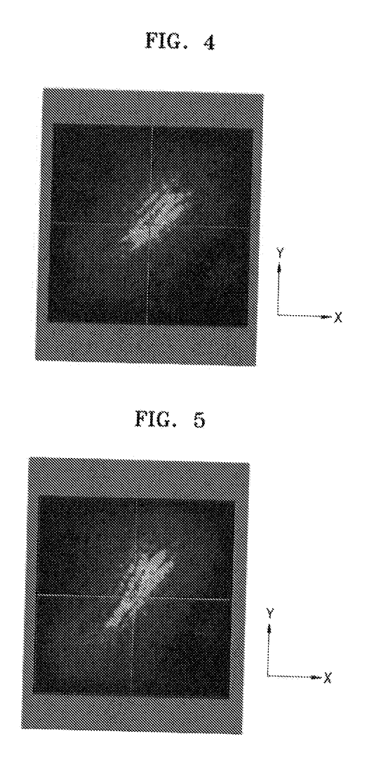

FIGS. 4 and 5 are views showing polarization distributions in cases where the angle θ is 45° and the angle θ is 60° in the illuminating apparatus of FIG. 2. The light emitted from the illuminating apparatus is polarized in the length direction of the exit unit 230.

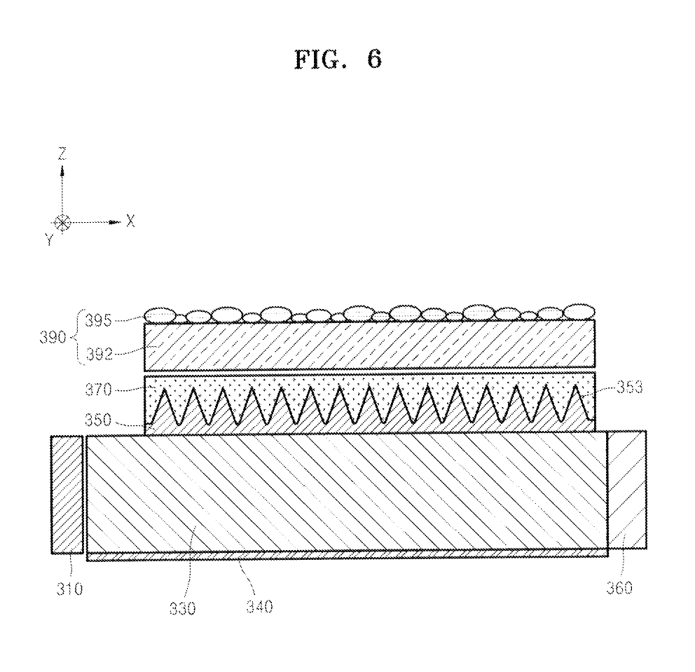

FIG. 6 shows an illuminating apparatus according to another exemplary embodiment of the present invention. Referring to FIG. 6, the illuminating apparatus of the current embodiment includes a light source 310, a first layer 330 which guides the light emitted from the light source 310, a second layer 350 formed on the first layer 330 and including exit units 353 that are arranged in a repeating fashion, a third layer 370 formed on the second layer 350 using an anisotropic material, and a diffusing film 390 formed on the third layer 370.

According to the current embodiment, the light that is polarized in a direction (Y axis) parallel to the light source 310 is emitted through the third layer 370. In addition, the diffusing film 390 has a phase delay property so that the light can be diffused with even brightness distribution by the diffusing film 390, and the polarization direction of the light can be changed. To do this, exit units 353, the length directions of which are in parallel with the Y axis, are arranged in a repeating fashion on the second layer 350 in the X-axis direction. In addition, the diffusing film 390 includes a base film 392 formed of an anisotropic material and a plurality of beads 395 attached to the base film 392 to scatter the light. The base film 392 is formed of the optically anisotropic material and delays a phase of the light having a predetermined polarization to change the polarization direction. The anisotropic axis or a thickness d of the base film 392 are appropriately determined in consideration of the polarization of the light incident on the diffusing film 390 and the polarization of the light that is emitted.

A reflective member 340 can be disposed on a lower surface of the first layer 330, and a polarization conversion member 360 can be further formed on a side portion of the first layer 330.

The light that is polarized in the Y-axis direction is emitted from the third layer 370 by the second layer 350 having the exit unit 353 and the third layer 370 formed of the anisotropic material. In addition, the base film 392 of the diffusing film 390 is formed of the anisotropic material, and the anisotropic axis and the thickness of the base film 392 are appropriately determined so that the light emitted from the third layer 370 can be changed to a discretionary direction after passing through the diffusing film 390.

As described above, the illuminating apparatus consistent with the present invention can easily determine the polarization direction of the light emitted upward by determining the pattern shape of the incident surface, the arrangement of the exit units, and the anisotropic axis direction. In addition, in an illuminating apparatus consistent with the present invention, the base film of the diffusing film is formed of the anisotropic material that can delay the phase of a certain polarization direction, and thus, the polarization direction of the light emitted upward can be adjusted. Therefore, an illuminating apparatus consistent with the present invention can be applied to various liquid crystal modes, and the light loss can be reduced to provide light having a high brightness.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An illuminating apparatus comprising:
a light source;
a first layer which guides light emitted from the light source and which includes an incident surface onto which the light is incident, an upper surface which emits the light, and a light facing surface facing the incident surface, where the incident surface has a prism pattern;
a second layer formed on the first layer and including exit units that are arranged in a repeating fashion in a first direction which forms a predetermined angle Θ with respect to a first axis parallel with the light source; and
a third layer formed on the second layer using an optically anisotropic material, an anisotropic axis of which is formed in a second direction that is perpendicular to the first direction,
wherein light polarized in the second direction is emitted from the illuminating apparatus.

2. The illuminating apparatus of claim 1, wherein the prism pattern includes a surface that is inclined at an angle of 90°-θ with respect to the first axis.

3. The illuminating apparatus of claim 2, wherein a vertical angle of the prism pattern is 2Θ.

4. The illuminating apparatus of claim 1, wherein each of the exit units is formed as a prism.

5. The illuminating apparatus of claim 1, wherein a side surface connecting the incident surface to the light facing surface is a reflective surface.

6. The illuminating apparatus of claim 1, wherein a reflective member is disposed on a lower surface of the first layer.

7. The illuminating apparatus of claim 1, wherein a polarization conversion member is disposed on the light facing surface.

8. The illuminating apparatus of claim 1, wherein a diffusing film is disposed on an upper surface of the third layer.

9. An illuminating apparatus comprising:
a light source;
a first layer which guides light emitted from the light source and which includes an incident surface onto which the light is incident, an upper surface which emits the light, and a light facing surface facing the incident surface;
a second layer formed on the first layer and including exit units that are arranged in a repeating fashion in a first axis direction that is perpendicular to the incident surface;
a third layer formed on the second layer using an optically anisotropic material; and
a diffusing film formed on the third layer, and including a base film formed of an anisotropic material and beads attached to the base film to scatter the light,
wherein light polarized in a direction forming a predetermined angle with the first axis is emitted from the illuminating apparatus.

10. The illuminating apparatus of claim 9, wherein each of the exit units is formed as a prism.

11. The illuminating apparatus of claim 9, wherein a reflective member is disposed on a lower surface of the first layer.

12. The illuminating apparatus of claim 9, wherein a polarization conversion member is disposed on a side portion of the first layer.
